(19) United States
(12) Patent Application Publication
(10) Pub. No.: US 2011/0100337 A1
(43) Pub. Date: May 5, 2011

(54) HIGH EFFICIENCY VAPOR SYSTEM FOR INTERNAL COMBUSTION ENGINES

(76) Inventor: MICHAEL WALLACE ORTH, Oklahoma City, OK (US)

(21) Appl. No.: 12/910,848

(22) Filed: Oct. 24, 2010

Related U.S. Application Data
(60) Provisional application No. 61/257,498, filed on Nov. 3, 2009.

(51) Int. Cl. F02M 33/02

(52) U.S. Cl. 123/519

(57) ABSTRACT

A high efficiency vapor system for an internal combustion engine of a lawn mower includes a vapor tank assembly which maintains a specific amount of fuel therein. An air inlet line is coupled to bottom of the vapor tank assembly and wrapped around a muffler for heating up the air inside. A vapor outlet line is coupled between top of the vapor tank assembly and the internal combustion engine. A mechanism within bottom of the vapor tank assembly is for vaporizing the fuel with heated air that enters from the air inlet line. The vapor outlet line will transport vaporized fuel into the internal combustion engine of the lawn mower, to enhance engine performance with less fuel consumption and significantly lower exhaust emissions.

### CROSS-REFERENCE TO RELATED APPLICATION

This application claims the benefit of Provisional Patent Application No. 61/257,498, filed on Nov. 3, 2009, in the United States Patent & Trademark Office, the disclosure of which is incorporated herein by reference.

### BACKGROUND OF THE INVENTION

1. Field of the Invention

The present invention relates to a fuel enhancement apparatus, and more particularly, a high efficiency vapor system for an internal combustion engine.

The high efficiency vapor system vaporizes fuel used in the internal combustion engine to make for better engine performance, less fuel consumption and significantly lower exhaust emissions. The present invention utilizes air heated by the exhaust of the engine to vaporize fuel. The vapors are then mixed with air via a mixing valve assembly, which can be adjusted for maximum combustion. Devices with internal combustion engines that run at fairly steady rpm's, such as lawnmowers or generators, could burn fuel in a much more efficient manor, ultimately saving users time and money.

2. Description of the Prior Art

Conventional fuel systems for lawn mowers, generators, and other similar devices do an inadequate job of vaporizing fuel. The fuel mixture typically flows through the engine too rapidly for it to burn completely. This inefficient design results in a fuel combustion rate of only about twenty to thirty percent. The remaining fuel is essentially unused, creating a large amount of waste in both product and money. In a world where fuel and exhaust emissions are increasingly important issues, consumers need a system that provides optimum efficiency for this type of combustible engine.

Numerous innovations for fuel vaporizing devices have been provided in the prior art that will be described. Even though these innovations may be suitable for the specific individual purposes to which they address, however, they differ from the present invention.

U.S. Pat. No. 5,074,273, issued on Dec. 24, 1991, to Brown teaches an improved carburetor and fuel pre-conditioner for internal combustion engines comprising a first air conduit; a bubble chamber receiving air from the conduit and for bubbling the air through a fuel; a vapor chamber for receiving the air-fuel mixture; catalytic beads held within the bubble chamber for contacting and cracking fuel coming into contact therewith; a second air conduit for receiving an independent source of atmospheric air; and one or more pill cans located between the vapor chamber and the second air conduit for controlling the richness of the air-fuel mixture which is fed from the second air conduit into the intake manifold of an internal combustion engine for superior efficiency. Another pill may be located between the vapor chamber and the intake manifold for controlling and feeding the highly volatile mixture from the vapor chamber directly to the intake manifold.

U.S. Pat. No. 6,526,952, issued on Mar. 4, 2003, to Price teaches a pre-combustion chamber fuel vaporization and aeration system for an internal combustion engine that includes a fuel vaporization and air mixing chamber housing having an aerated fuel vapor outlet opening, a fuel inlet system, and an air inlet system. A fuel supply method for supplying fuel and air to an intake manifold of an internal combustion engine having a fuel tank is also provided that includes the steps of a) providing a pre-combustion chamber fuel vaporization and aeration system for internal combustion engines; b) installing the fuel inlet system in connection with the gas tank; and c) installing the aerated fuel vapor outlet opening in connection with the intake manifold of the internal combustion engine.

US20040103858, published on Jun. 3, 2004, to Shetley teaches a fractionating vaporized fuel system which provides a mixture of fresh air and vaporized lower boiling fractions of gasoline to the intake passage of an internal combustion engine. More specifically, the system uses hot engine coolant to vaporize the lower boiling fractions of a fuel such as gasoline for combustion as a vapor, and the higher boiling fractions are returned to the tank as a liquid for other uses. Intake air is heated by the exhaust manifold before being drawn through a vaporizing chamber and mixed with the vaporized fuel. The warm air/vaporized fuel mixture is then introduced to the engine prior to the choke plate of a carbureted or fuel injected engine. In this manner the vaporized fuel system is able to provide improved efficiency and reduced emissions throughout the entire range of engine requirements.

U.S. Pat. No. 6,746,002, issued on Jun. 8, 2004, to Jones teaches a fuel expansion system or carburetor for internal combustion engines utilizing the bubbling of air through use of a number of bubble tubes through a supply of liquid fuel. The resulting atomized, vaporized and expanded fuel is then mixed with air and fed into the engine for combustion.

US20090314261, published on Dec. 24, 2009, to Hasebe et al. teaches a working machine in which: an engine and a fuel tank for the engine are mounted on a machine body; an air cleaner mounted outside the machine body has a cleaner case including a cylindrical case body and a lid body being mounted on one end of the case body, and a cleaner element being housed in the cleaner case and dividing the inside of the cleaner case into a pre-purification chamber and a post-purification chamber; and an air-outlet pipe is connected to an intake system of the engine with an intake duct interposed therebetween, a canister capable of absorbing a vaporized fuel generated in the fuel tank is attached to the fuel tank or the machine body; a purge joint communicating with the post-purification chamber is provided to the lid body of the air cleaner; and a purge conduit extending from the canister is connected to the purge joint. Accordingly, it is possible to take a vaporized fuel generated in the fuel tank into the engine by utilizing the lid body of the air cleaner.

US20070251511, published on Nov. 1, 2007, to Vincent Potier discloses a fuel tank system with conduit systems comprising a first conduit means (a) to conduct the fuel vapor/air mixture from the fuel tank to the vapor storage canister; a second conduit means (b) to conduct the hot air from the heat exchanger to the vapor storage canister in order to heat the adsorbent material to a purge temperature above an ambient temperature in the fuel tank, at which purge temperature the adsorbed fuel vapor fraction of the fuel vapor/air mixture vaporizes and fills the vapor storage canister with hot fuel vapor; a third conduit means (c) to conduct fresh air from the outside to the heat exchanger; and a fourth conduct means (d) to conduct the hot fuel vapor from the canister to the internal combustion engine so that the hot fuel vapor is combusted therein. The heat exchanger is located in the proximity of an exhaust pipe of the internal combustion engine. Between the heat exchanger and the exhaust pipe there is located a thermal insulation means preventing the fuel tank from absorbing to much heat radiation which is emitted from the exhaust pipe.

U.S. Pat. No. 4,705,008, issued on Nov. 10, 1987, to Edward O. Kleinholz discloses an internal combustion engine whereupon is mounted vapor generator, exhaust manifold encased in jacket 61 and connected onto the manifold is exhaust pipe, which the pipe in turn is partially encased by air conduit sheath enclosure 60, wherein ambient air is superheated, then conveyed by means of conduit to butterfly air-flow control and consequently into the heat exchanger chamber of generator. Ambient air is drawn into sleeve surrounding the exhaust pipe and into manifold enclosure, whereupon the incoming air is heated to super hot temperature and is coursed into the heat exchange chambers, and out of generator through outlet and coursed by means of conduit to a venturi system adjoined onto exhaust pipe. The venture system provides the motivating force for moving the ambient and superheated air.

US20020148354, published on Oct. 17, 2002, to Noriyasu Amano et al. discloses a fuel vapor control apparatus which has a canister for temporarily adsorbing and storing fuel vapors generated in a fuel tank. At the time of desorption of fuel vapors (engine operation), the three way valve V1 is opened to the path side, and high-temperature air as a heating medium heated by the heat of the exhaust pipe is introduced into the temperature control layer.

U.S. Pat. No. 6,105,708, issued on Aug. 22, 2000, to Atsushi Amano et al. discloses an evaporated-fuel collecting apparatus connected to the internal combustion engine. The evaporated-fuel collecting apparatus includes a canister having an absorbent incorporated in a canister case, to which canister case one end of each of two evaporating hoses, a purge hose, and a hose is connected. The valve is connected by means of a pipe to an air filter 167 which is open to outside air. The canister is kept warm by heat from the exhaust pipe while the internal combustion engine 106 is operating and the vehicle is running. Specifically, the L-shaped portion of pipe effectively wraps around the right front corner of the fuel tank in close association with the canister 150 so the exhaust heat effectively warms the canister.

US20090241861, issued on Oct. 1, 2009, to Tadashi Sano discloses an engine having an intake pipe for taking in air for combustion thereunto, a reactor vessel with a catalyst supported therein for decomposing a hydrogen medium, a hydrogen medium tank storing the hydrogen medium, a high-pressure pump for pressurizing and transporting the hydrogen medium, a first heat exchanger for exchanging heat with the hydrogen medium in a liquid state, a second heat exchanger for exchanging heat with the hydrogen medium in a gas state. Reactor vessel is disposed in the exhaust pipe so that the reactor vessel can exchange heat with the exhaust pipe.

It is apparent now that numerous innovations for fuel vaporizing devices have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a high efficiency vapor system for an internal combustion engine that avoids the disadvantages of the prior art.

ANOTHER OBJECT of the present invention is to provide a high efficiency vapor system for an internal combustion engine that is simple and inexpensive to manufacture.

STILL ANOTHER OBJECT of the present invention is to provide a high efficiency vapor system for an internal combustion engine that is simple to use.

BRIEFLY STATED, STILL YET ANOTHER OBJECT of the present invention is to provide a high efficiency vapor system for an internal combustion engine comprises a vapor tank assembly which maintains a specific amount of fuel therein. An air inlet line is coupled to bottom of the vapor tank assembly. A vapor outlet line is coupled between top of the vapor tank assembly and the internal combustion engine. A mechanism within bottom of the vapor tank assembly is for vaporizing the fuel with air that enters from the air inlet line. The vapor outlet line will transport vaporized fuel into the internal combustion engine, to enhance engine performance with less fuel consumption and significantly lower exhaust emissions.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a diagrammatic view showing the various components of the present invention;

FIG. 2 is a side view, with parts broken away, taken in the direction of arrow 2 in FIG. 1, showing how the air inlet line is wrapped around the muffler of the engine of the lawn mower;

FIG. 3 is an enlarged partially exploded perspective view, showing the mixing valve assembly in FIG. 1 in greater detail;

FIG. 4 is an enlarged partially exploded perspective view of the area in FIG. 1 indicated by arrow 4, showing the air filter assembly in greater detail;

FIG. 5 is an enlarged exploded perspective view of the area in FIG. 1 indicated by arrow 5, showing the vapor tank assembly in greater detail; and

FIG. 6 is a perspective view, with parts broken away, showing the present invention mounted on a lawn mower.

### REFERENCE NUMERALS UTILIZED IN THE DRAWING

110 high efficiency vapor system
112 internal combustion engine
114 vapor tank assembly of vapor system 110
116 fuel
118 air inlet line of vapor system 110
120 vapor outlet line of vapor system 110
122 vaporizing mechanism of vapor system 110
124 central housing member of vapor tank assembly 114
126 lower housing member of vapor tank assembly 114
128 upper housing member of vapor tank assembly 114
130 perforated plate for vaporizing mechanism 122
132 stationary fan in vapor tank assembly 114
134 first T-fitting of vapor tank assembly 114
136 drain cock at bottom end 138
138 bottom end of first T-fitting 134
140 top end of first T-fitting 134
142 side end of first T-fitting 134
144 second T-fitting of vapor tank assembly 114
146 bottom end of second T-fitting 144
148 side end of second T-fitting 144
150 removable filler plug of vapor tank assembly 114
152 top end of second T-fitting 144
154 muffler of internal combustion engine 112
156 air filter assembly of vapor system 110
158 X-fitting of air filter assembly 156
160 first end of X-fitting 158
162 back flow prevention valve of air filter assembly 156
164 top end of back flow prevention valve 162
166 second end of X-fitting 158
168 main valve of air filter assembly 156
170 bottom end of main valve 168
172 third end of X-fitting 158
174 air breather component of air filter assembly 156
176 bottom end of air breather component 174
178 top end of main valve 168
180 foam air filter in air breather component 174
182 second air inlet line of vapor system 110
183 bottom end of back flow prevention valve 162
184 primer pump of vapor system 110
186 third air inlet line of vapor system 110
188 fourth end of X-fitting 158
190 mixing valve assembly of vapor system 110
192 vapor valve of mixing valve assembly 190
194 control lever of vapor valve 192
196 air valve of mixing valve assembly 190
198 control lever of air valve 196
200 connecting rod between control levers 194, 198
210 lawn mower

### DETAILED DESCRIPTION OF THE PREFERRED EMBODIMENT

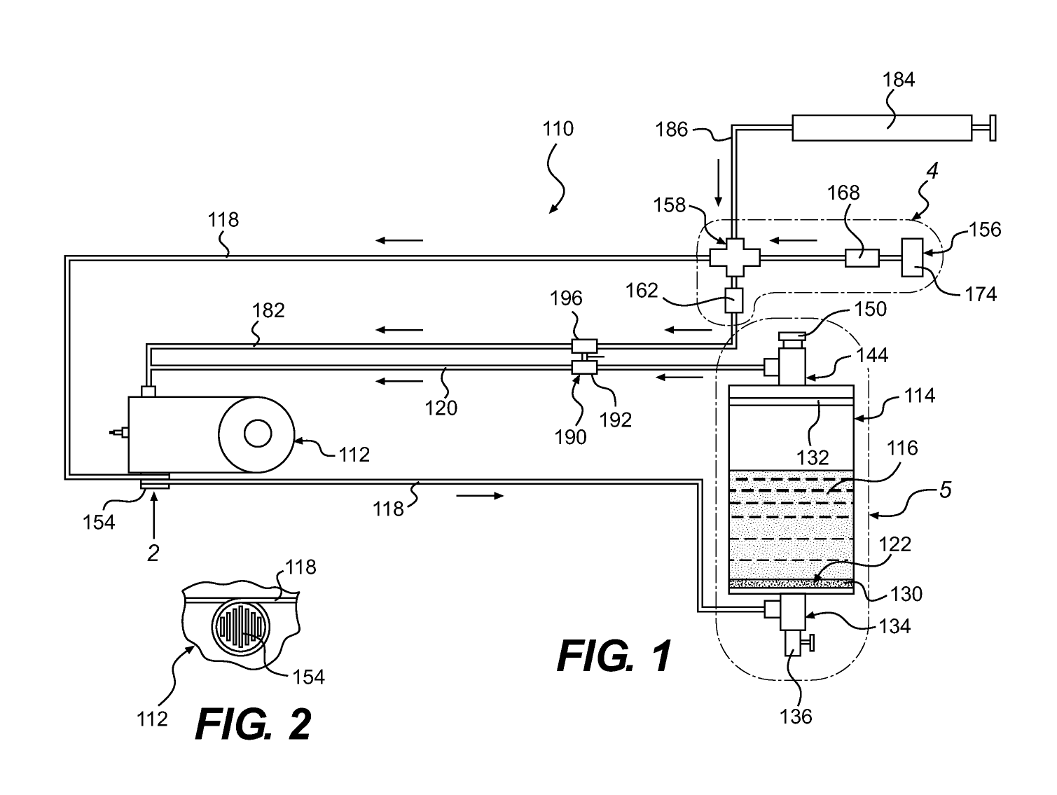

Referring now to the figures, in which like numerals indicate like parts, and particularly to FIGS. 1 through 6, and as such, will be discussed with reference thereto.

The present invention, as shown in FIG. 1, is a high efficiency vapor system 110 for an internal combustion engine 112 of a lawn mower 210, that comprises a vapor tank assembly 114 which maintains a specific amount of fuel 116 therein. An air inlet line 118 is coupled to bottom of the vapor tank assembly 114. The air inlet line 118 is wrapped around a muffler 154 of the engine 112. The air (inside inlet line 118) is heated by the hot exhaust from the muffler 154. A mechanism 122 within bottom of the vapor tank assembly 114 is for vaporizing the fuel 116 with heated air that enters from the air inlet line 118. The inlet line 118 is made of stainless steel tubing coils, non-corrosive tubing coils or copper tubing coils. A vapor outlet line 120 is coupled between top of the vapor tank assembly 114 and the internal combustion engine 112 of the lawn mower 210. The vapor outlet line 120 will transport vaporized fuel 116 into the internal combustion engine 112, to enhance engine performance with less fuel consumption and significantly lower exhaust emissions.

As best seen in FIG. 2, the air inlet line 118 is wrapped about the muffler 154 of the internal combustion engine 112 to supply heat to incoming air within the air inlet line 118. The air can be heated up to 400° degrees. The vapor system 110 further comprises an air filter assembly 156 coupled to the internal combustion engine 112 and to the air inlet line 118.

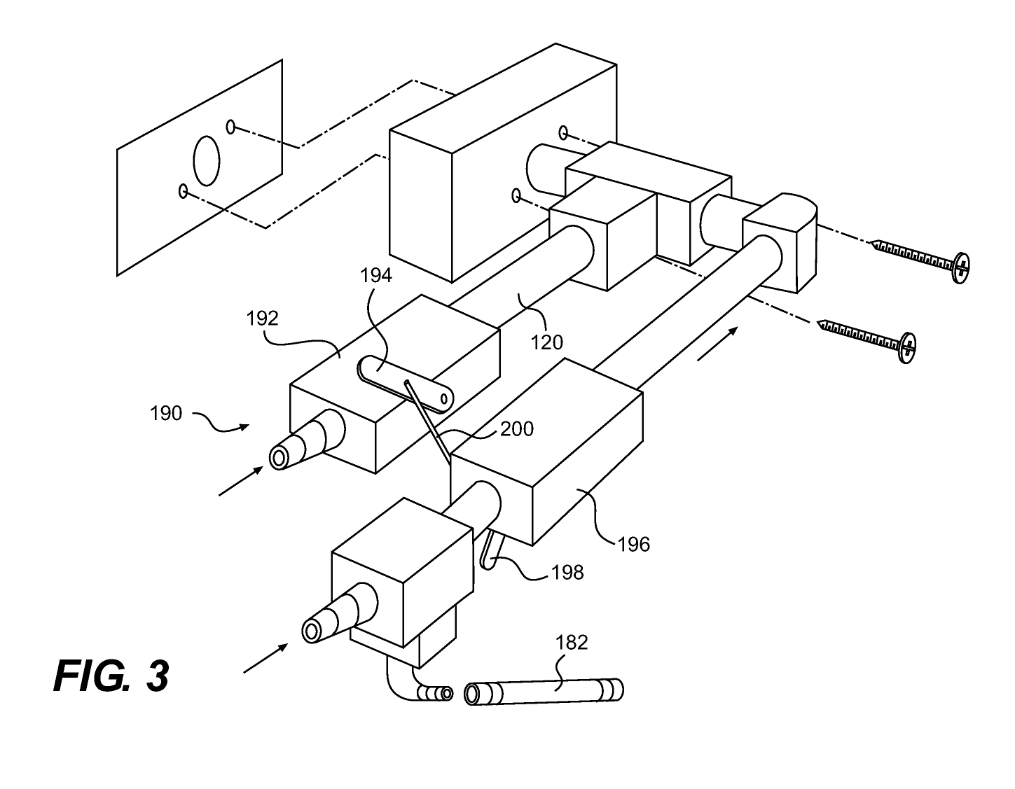

As shown in FIG. 3, the other main component of the vapor system 110 is the mixing valve assembly 190. The vapor outlet line 120 is connected to the vapor valve 192. The air valve 196 is used to control the air mixture. The valves 192, 196 are one quarter turn types, in which their control levers 194, 198 are connected together with the connecting rod 200, so that when one valve is fully open the other valve will be fully closed, and vise versa. The T-fittings 134, 144 on the vapor tank assembly 114 are used for connection to the air inlet line 118 and the vapor outlet line 120. The vapor inlet line 120 may include a fine mesh screen (not shown) that would prevent flame from penetrating the vapor tank assembly 114 in the case of an engine 112 backfire. The vapor inlet line 120 then connects to a butterfly valve assembly or the like that incorporates a standard governor and throttle control typically found on a small engine. The air inlet line 182 of the air valve 194 may branch off of the back flow prevention valve 162, the primer pump 184, and the air inlet line 120 of the vapor tank assembly 114. The air inlet line 182 of the back flow prevention valve 162 will connect to the air valve 194. Dimensions and other specifications may vary upon manufacturing.

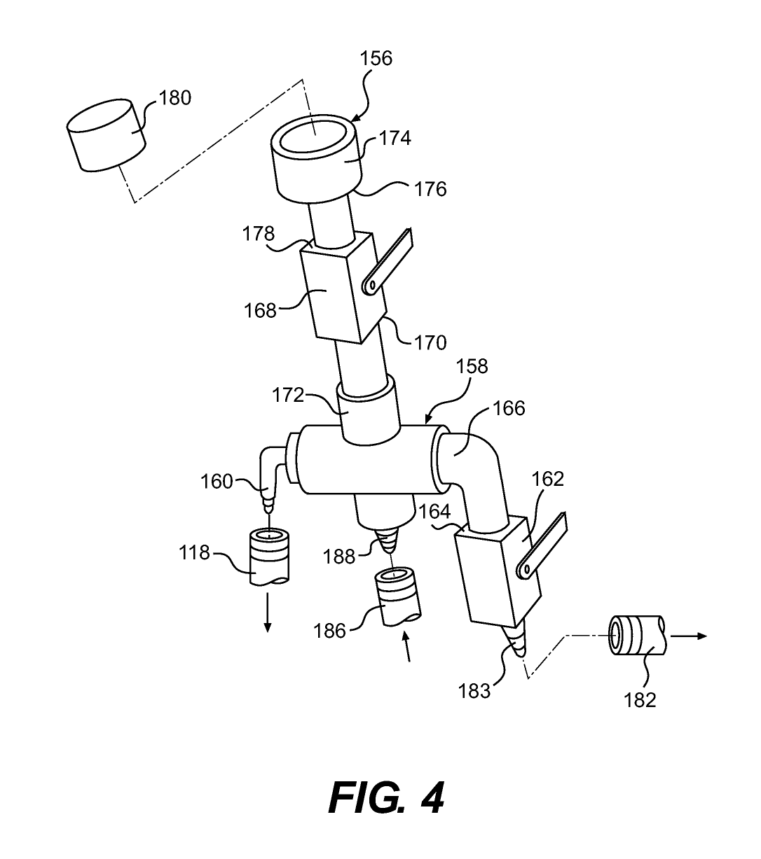

As shown in FIG. 4, the air filter assembly 156 comprises an X-fitting 158 that has a first end 160 connected to the air inlet line 118. A back flow prevention valve 162 has a top end 164 connected to a second end 166 of the X-fitting 158. A main valve 168 has a bottom end 170 connected to a third end 172 of the X-fitting 158. An air breather component 174 has a bottom end 176 connected to a top end 178 of the main valve 168. A foam air filter 180 is inserted within the air breather component 174. A second air inlet line 182 is coupled between a bottom end 183 of the back flow prevention valve 162 and the internal combustion engine 112 of the lawn mower 210.

The vapor system 110 further comprises a primer pump 184. A third air inlet line 186 is coupled between the primer pump 184 and a fourth end 188 of the X-fitting 158. The vapor system 110, as best seen in FIG. 3, further comprises a mixing valve assembly 190 having a vapor valve 192 with a control lever 194, an air valve 196 with a control lever 198 and a connecting rod 200 between the control levers 194, 198. The vapor valve 192 is coupled into the vapor outlet line 120 and the air valve 196 is coupled into the second air inlet line 182. Operation of the control lever 194 of the vapor valve 192 will cause the control lever 198 of the air valve 196 to move in an opposite direction by the connecting rod 200 to control the amount of air mixture traveling through the mixing valve assembly 190.

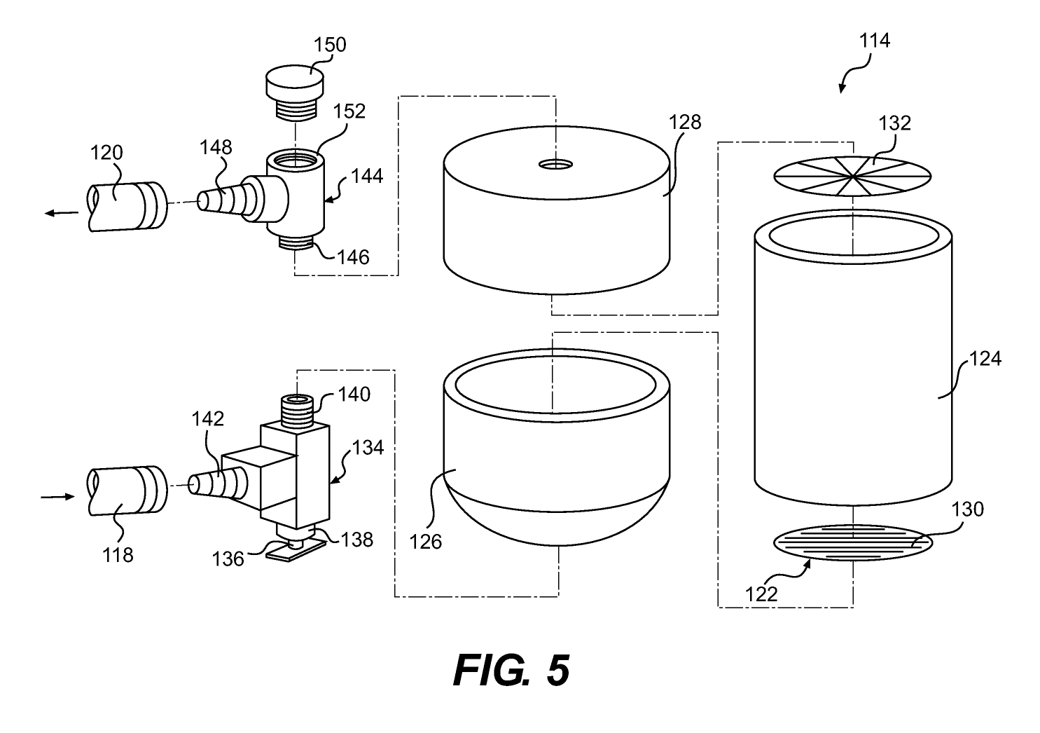

The vapor tank assembly 114, as best seen in FIG. 5, comprises a central housing member 124. A lower housing member 126 is connected to bottom of the central housing member 124. An upper housing member 128 is connected to top of the central housing member 124. The vaporizing mechanism 122 comprises a perforated plate 130 located in the lower housing 126 to disperse the heated incoming air into a myriad of fine bubbles within the fuel 116.

A stationary fan 132 is located in the upper housing 128. When additives are added to the fuel 116, the additives will cause the fuel 116 to excessively foam and choke the internal combustion engine 122 of the lawn mower 210. The stationary fan 132 will cause the vapor mixture within the vapor tank assembly 114 to spin, which in turn will force the foam against inner sides of the vapor tank assembly 114 and allow the foam to go back to the bottom.

The vapor tank assembly 114 further comprises a first T-fitting 134 that has a drain cock 136 at a bottom end 138. A top end 140 is threaded into bottom of the lower housing member 126 and a side end 142 is connected to the air inlet line 118. A second T-fitting 144 has a bottom end 146 threaded into top of the upper housing member 128 and a side end 148 connected to the vapor outlet line 120. A removable filler plug 150 is threaded into a top end 152 of the second T-fitting 144.

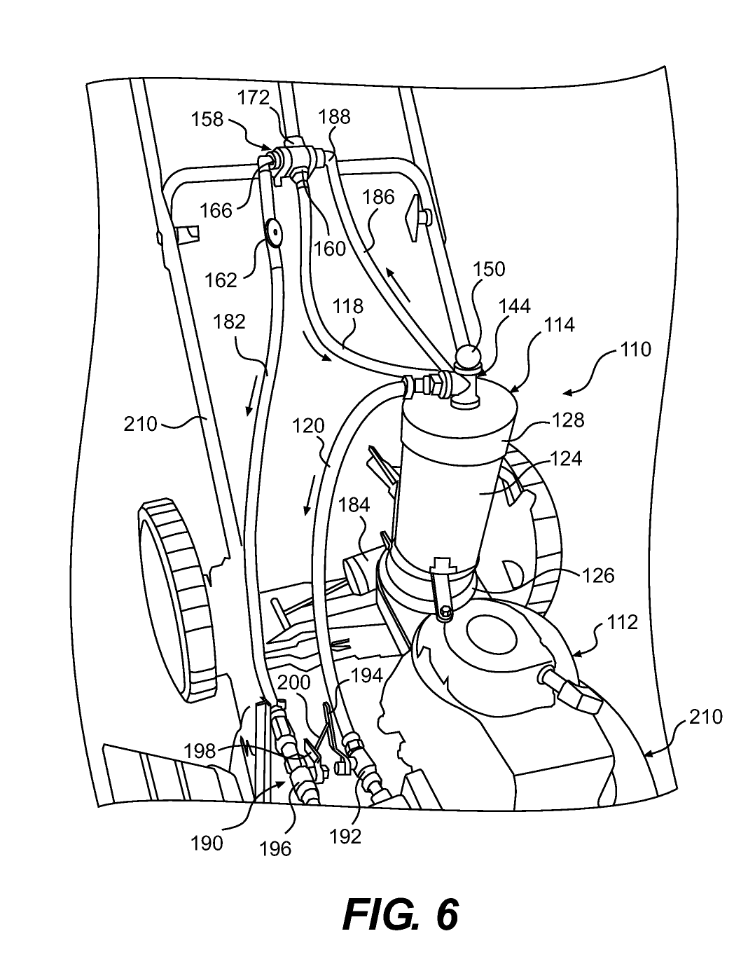

In summary, the high efficiency vapor system 110 provides a user with a more efficient fuel burning method for the internal combustion engine 112 of the lawn mower 210. The present invention works well with most standard 3.5 horsepower engines, such as in a lawn mower 210, as shown in FIG. 6. With gasoline and other flammable fuels, it is not the fuel 116 that burns but rather the vapors. The vapor system 110 is designed to vaporize the fuel 116 prior to introducing the mixture into the engine intake, thereby allowing for maximum combustion. The main component of the present invention is the vapor tank assembly 114 that can be made of aluminum, stainless steel or other non-corrosible materials.

The vapor tank assembly 114 is attached to the engine 112 to allow heat from the engine 112 to transfer to the vapor tank assembly 114. The vapor tank assembly 114 may be cylindrical, measure approximately four inches in diameter, be eight inches tall, hold approximately two quarts of fuel 116, and has the filler plug 150 on the top and the drain cock 136 on the bottom. The vapor tank assembly 114 also has the perforated plate 130 in the bottom that disperses incoming air into a myriad of fine bubbles. The air inlet line 118 can be tubing made of high grade stainless steel or other suitable materials and will wrap around the engine muffler 154 to heat the incoming air. The vapor tank assembly 114 should be filled only approximately half way with the fuel 116 to prevent raw fuel from being drawn into the engine 112 of the lawn mower 210. As shown in FIG. 1, the primer pump 184 is incorporated into the vapor system 110 in which the user would pump the primer pump 184 from five to ten times. The primer pump 184 can be a foot pump or hand pump to create a sufficient vapor charge, making the engine 112 easier to start.

The vapor system 110 may be constructed as an after market add-on unit in which the OEM carburetor, throttle and governor controls of the engine 112 would remain intact. The OEM fuel tank, fuel line and air breather of the engine 112 are removed. The carburetor fuel inlet is capped-off and fuel 116 is drained from the float bowl. The vapor system 110 is connected thereto by an adapter plate. The primer pump 184 can be commercially available as a foot or hand pump and will connect to the barbed end 188 on the lower side of the X-fitting 158 by the air inlet line 186 which can be a nylon hose secured with hose clamps.

It will be understood that each of the elements described above, or two or more together, may also find a useful application in other types of constructions differing from the types described above.

While the invention has been illustrated and described as embodiments of a high efficiency vapor system for an internal combustion engine of a lawn mower, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A high efficiency vapor system for an internal combustion engine of a lawn mower which comprises:
a) a vapor tank assembly which maintains a specific amount of fuel therein;
b) an air inlet line coupled to bottom of the vapor tank assembly and formed as tubing coils wrapping around a muffler of the internal combustion engine wherein the air in the air inlet line is heated by the exhaust from the muffler;
c) a vapor outlet line coupled between top of the vapor tank assembly and the internal combustion engine; and
d) means, within bottom of the vapor tank assembly, for vaporizing the fuel with the heated air that enters from the air inlet line, whereby the vapor outlet line will transport vaporized fuel into the internal combustion engine to enhance engine performance with less fuel consumption and significantly lower exhaust emissions.

2. The vapor system as recited in claim 1, wherein the vapor tank assembly comprises:
a) a central housing member;
b) a lower housing member connected to bottom of the central housing member; and
c) an upper housing member connected to top of the central housing member.

3. The vapor system as recited in claim 2, wherein the vaporizing means comprises a perforated plate located in the lower housing to disperse incoming heated air into a myriad of fine bubbles within the fuel.

4. The vapor system as recited in claim 3, further comprising a stationary fan located in upper housing, wherein when additives are added to the fuel, the additives will cause the fuel to excessively foam and choke the internal combustion engine, wherein the stationary fan will cause the vapor mixture within the vapor tank assembly to spin, which in turn will force the foam against inner sides of the vapor tank assembly and allow the foam to go back to the bottom.

5. The vapor system as recited in claim 2, wherein the vapor tank assembly further comprises:
a) a first T-fitting having a drain cock at a bottom end, a top end threaded into bottom of the lower housing member and a side end connected to the air inlet line;
b) a second T-fitting having a bottom end threaded into top of the upper housing member and a side end connected to the vapor outlet line; and
c) a removable filler plug threaded into a top end of the second T-fitting.

6. The vapor system as recited in claim 1, wherein the tubing coils of air inlet line are select from a group consisting of stainless steel tubing coils, non-corrosive tubing coils and copper tubing coils.

7. The vapor system as recited in claim 1, further comprising an air filter assembly coupled to the internal combustion engine and to the air inlet line.

8. The vapor system as recited in claim 7, wherein the air filter assembly comprises:
a) an X-fitting having a first end connected to the air inlet line;
b) a back flow prevention valve having a top end connected to a second end of the X-fitting;
c) a main valve having a bottom end connected to a third end of the X-fitting;
d) an air breather component having a bottom end connected to a top end of the main valve;
e) a foam air filter inserted within the air breather component; and
f) a second air inlet line coupled between a bottom end of the back flow prevention valve and the internal combustion engine.

9. The vapor system as recited in claim 8, further comprising:
a) a primer pump; and
b) a third air inlet line coupled between the primer pump and a fourth end of the X-fitting.

10. The vapor system as recited in claim 8, further comprising a mixing valve assembly having a vapor valve with a control lever, an air valve with a control lever and a connecting rod extending between the control levers, wherein the vapor valve is coupled into the vapor outlet line and the air valve is coupled into the second air inlet line, whereby operation of the control lever of the vapor valve will cause the control lever of the air valve to move in an opposite direction by the connecting rod to control the amount of air mixture traveling through the mixing valve assembly.

11. The vapor system as recited in claim 10, wherein the vapor outlet line which is connected to a vapor valve; and
an air valve is used to control the air mixture.

12. The vapor system as recited in claim 11, further comprising the valves which are one quarter turn types, in which their control levers are connected together with the connecting rod, so that when one valve is fully open, the other valve will be fully closed, and vise versa.

13. The vapor system as recited in claim 1, wherein the vapor tank assembly may be cylindrical, measure approximately four inches in diameter, be eight inches tall, hold approximately two quarts of fuel.
